(19) United States
(12) Patent Application Publication
(10) Pub. No.: US 2024/0333645 A1
(43) Pub. Date: Oct. 3, 2024

(54) IDENTIFYING USERS AND DEVICES THAT REQUEST SERVICE

(71) Applicant: Comcast Cable Communications, LLC, Philadelphia, PA (US)

(72) Inventors: Saravanan MUTHUSAMY, Wayne, PA (US); Eric B. SCHRAG, Wilmington, DE (US)

(21) Appl. No.: 18/194,239

(22) Filed: Mar. 31, 2023

(51) Int. Cl. H04L 45/741; H04L 9/40; H04W 4/02

(52) U.S. Cl. CPC H04L 45/741; H04L 63/0272; H04W 4/025

(57) ABSTRACT

Methods are disclosed for an authorization system to determine whether a user is in-home, for example, to facilitate providing services or content based on location of the requesting user.

### BACKGROUND

There are many examples in which online services or content are made available to users, and certain geographical restrictions may be placed on the delivery of such services or content to those users. For example, due to geographic restrictions, a service provider may only be licensed to stream content to users who are “in-home” in a particular geographic area. Various techniques are available for identifying the location of a requesting user, such as matching the source internet protocol (IP) address in a packet received from the user's in-home Wi-Fi router or gateway with the known IP address of the router/gateway associated with the user's account. However, privacy products such as virtual private networks (VPNs) and/or relay servers can hide or obfuscate the IP address. This makes it difficult for an authorization system to verify and comply with geographical restrictions placed on the delivery of certain services and content. Therefore, improved systems and methods for determining location of a user or a device are needed.

### SUMMARY

Methods are disclosed for an authorization system to determine whether a user or device is in-home, for example, to facilitate providing services or content based on the location of the requesting user or device. As an example, a user device, or an application running on the user device, may request access to content or a service from a service provider. The request from the user device may be forwarded, by a user's in-home router or gateway device and via a network operated by the service provider, to an authorization system. The user device may be utilizing a privacy product, such as a VPN, relay server, or equivalent, to obfuscate the network address, such as an IP address, associated with the user's in-home router or gateway device. The requested content or service may have geographic location restrictions.

The request received by the authorization system may comprise a user identifier associated with a user of the user device, but the source address associated with the request may comprise the obfuscated network address, rather than the actual network address associated with the user's in-home router or gateway device. The authorization system may use the user identifier to determine account information associated with the user. The user account information may comprise the actual network address (e.g., IP address) of the user's in-home router. Using the network address of the user's in-home router, the authorization system may send to the router a message instructing the router to transmit (e.g., broadcast, multicast, or otherwise send) a code, such as, for example, a random secret code, at the user's premises. If the requesting user device is located at the premises, an application executing on the user device may receive the transmitted code and may send a second message to the authorization system that includes the code. Based on receiving the message from the user device that includes the code, the authorization system may determine that the user device is located at the premises, even though the source address associated with the user's initial request did not match the known network address of the user's in-home router or gateway device. If the user device is determined to be located at the premises, the authorization system may authorize the access to the geographically restricted content or service by the user device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 shows an example system.

FIG. 2 shows an example method.

FIG. 3 shows an example method.

FIG. 4 shows another example method.

FIG. 5 shows an example computing device.

### DETAILED DESCRIPTION

There are many examples in which online services or content are made available to users, but certain geographical restrictions are placed on the delivery of such services or content to those users. For example, service providers may provide content to users based on a license from the content owner. Such licenses may include restrictions related to the user's geographical location. For example, a content owner, such as the National Football League (NFL), might place license restrictions on Philadelphia Eagles home games, such that only users in the greater Philadelphia area are permitted to stream that specific content. These types of license restrictions must be enforced by service providers and other content distributors. In the past, it was possible for a service provider or content distributor to recognize when a user is trying to access a service or view content within a permitted geographic area, such as the user's home. For example, a user device on which the user is attempting to view content of access a service may be connected to an in-home router or gateway that connects to a network operated by the service provider. A message or packet requesting the service or content that is transmitted to the service provider via the in-home router/gateway may include a source internet protocol (IP) address of the router/gateway. By matching the source IP address in the packet received from the user's in-home router/gateway with the known IP address of the router/gateway associated with the user's account, the service provider could confirm that the user is requesting to access the service or view content in the user's home within the permitted geographic area. However, with the advent of VPNs, relay servers, and the like which can obfuscate the IP address of the user's in-home router/gateway, it has become harder for service providers and content distributors to confirm a user's actual geographical location. Disclosed herein are systems, methods, and apparatuses for an authorization system of a service provider to determine whether a user is attempting to access a service or consume content at the user's premises.

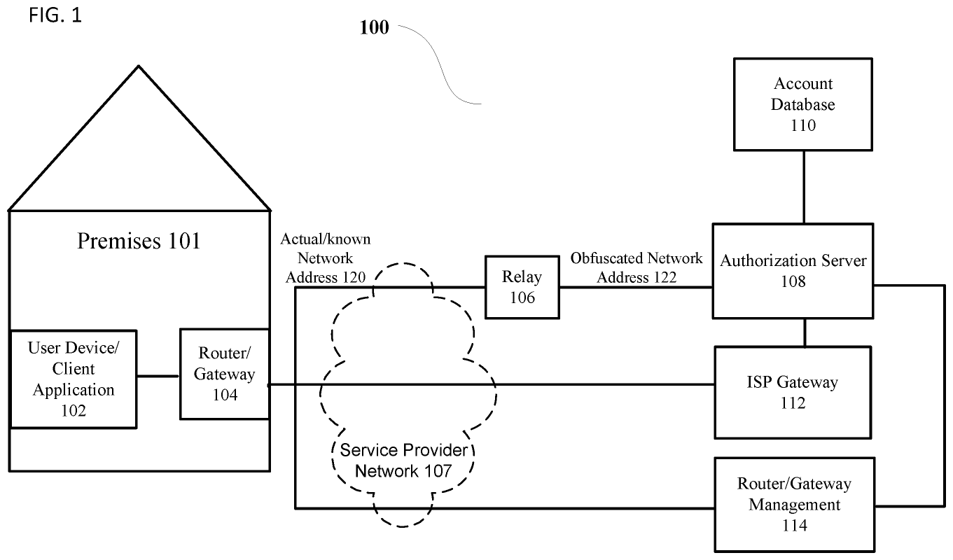

FIG. 1 shows an example system 100. The system 100 may comprise various devices located, for example, at a premises 101. The premises 101 may comprise a home, a business, or any other bounded geographic location.

The system may comprise a user device 102 located at the premises 101. The user device 102 may comprise, for example, a laptop computer, a desktop computer, a mobile phone, a television, a set-top box, a tablet, a wearable computing device, a mobile computing device, or any other computing device configured to receive and/or output (e.g., playback) content.

The user device 102 may be configured to host an application that a user may use to facilitate access to a service or content provided by a service provider. For example, the application may comprise a video streaming client that may connect to a server of a service provider, via a network operated by the service provider, in order to request and receive content from the service provider. For example, the user device 102 may be configured to receive recorded content in a base media file format (BMFF), in a standard format determined by the Moving Picture Experts Group (MPEG), such as a transport stream (TS) defined by MPEG, for example MPEG-TS, or the like. The user device 102 may be configured to receive the content and output the content (e.g., playback) for consumption by the user. The user device 102 may be configured to receive live streamed content and output the live streamed content, for example, a live broadcast of a football game.

A router (which may also be referred to as a gateway) 104 may also be located at the premises 101. The router/gateway 104 may provide access to a network 107 of a service provider. The service provider may also operate as a content distributor. The service provider may provide users with access to a variety of services or content. The router/gateway 104 may be configured to enable user devices, such as the user device 102, to establish a wired or wireless connection to the router/gateway 104 for purposes of communicating with the router/gateway 104 and other network apparatuses beyond the router/gateway 104. The router/gateway 104 may be configured to establish a wired and/or wireless local area network to which the devices may connect. For purposes of communicating wirelessly, the router/gateway 104 may implement a wireless access technology, such as the IEEE 802.11 (“Wi-Fi”) radio access technology. In other implementations, other radio access technologies may be employed, such as IEEE 802.16 or 802.20 (“WiMAX”), IEEE 802.15.4a (“Zigbee”), or 802.15.3c (“UWB”). For purposes of communicating with the router/gateway 104 via a wired connection, the gateway may be configured to implement a wired local area network technology, such as IEEE 802.3 (“Ethernet”) or the like.

The router/gateway 104 may be configured to communicate with the service provider network 107. The router/gateway 104 may communicate with the service provider network 107 via any of a variety of communications mediums, such as a coaxial cable network, a fiber-optic cable network, a hybrid fiber-coaxial (HFC) network, a satellite transmission channel, or the like. When part of a cable television system, the service provider network 107 may comprise a cable modem termination system (CMTS).

The router/gateway 104 may have an associated network address that uniquely identifies the router/gateway 104 on the service provider network 107. The network address may comprise, for example, an internet protocol (IP) address. The router/gateway 104 may be configured to perform network address translation (NAT) when sending packets of data from a user device, such as the user device 102, to the service provider network 107. Such network address translation may involve changing a source address in the header of packets received from the user device and destined for the service provider network 107, from the local IP address of the user device on the local area network established by the router/gateway at the premises 101 to the network address (e.g., IP address) of the router/gateway 104 on the service provider network 107.

The service provider network 107 may provide various services to user devices, such as the user device 102, and may include the appropriate infrastructure for these services. For example, the service provider network 107 may include one or more network routers (not shown). The network routers may comprise one or more edge routers, which may provide connectivity to other networks, including the Internet, a telephone network, or the like.

The service provider network 107 may provide user devices, such as the user device 102, with access to a content delivery network, which may comprise one or more content servers (not shown) that are configured to send, e.g., stream, content to such user devices. The content server(s) may be configured to send, to a user device and based on a request from the user device, a variety of different types of content, including live content, video-on-demand content, or other content.

The service provider network 107 may also comprise an authorization system, which, for example, may comprise an authorization server 108, that is configured to determine whether a user, or a user device associated with the user, is permitted to access a requested service or requested content.

The service provider network 107 may also comprise an account database 110, which may store records associated with users that have established accounts with the service provider for delivery of services or content to the user. The account database may store, for each user, information associated with the user's account. The account information for each user may comprise, for example, credentials associated with the user's account. The credentials may comprise, for example, an identifier associated with the user (e.g., a username, email address, or other identifier). The credentials may further comprises a password or other form of secure access token associated with the user identifier.

When a user wishes to access a service or content provided by the service provider via, for example, a user device, such as the user device 102, the user may be presented with a prompt requiring the user to enter the user's account credentials (e.g., username and password). The authorization server 108 may receive the user's credentials from the user device 102 and access the account database 110 to validate the credentials before providing access to services or content hosted by the service provider.

The service provider network 107 may further comprise a service provider gateway 112 that may be configured to communicate across the service provider network 107 with one or more, and potentially thousands of, router/gateways located at the premises of different users, including, for example, the router/gateway 104 located at the premises 101. The service provider gateway 112 may store, for each router/gateway connected to the service provider network 107, information associating the unique IP address of the router/gateway on the service provider network 107 with information identifying the user account associated with the user of that router/gateway.

The service provider network may further comprise a router/gateway management device (e.g., server) 114. The router/gateway management device 114 may be configured to communicate with each router/gateway (e.g., router/gateway 104) connected to the service provider network 107 for purposes of configuration and management of the router/gateways. For example, the router/gateway management device 114 may be configured to send messages (e.g., commands) to each router/gateway (e.g., router/gateway 104) in order to control the functionality of the router/gateway. Communications between the router/gateway management device 114 and a router/gateway (e.g., router/gateway 104) connected to the service provider network 107 may be transmitted over a control plane of the service provider network 107.

As mentioned above, the router/gateway 104 may be configured to perform network address translation (NAT) when sending packets of data from a user device, such as user device 102, to the service provider network 107. Such network address translation may involve changing a source address in the header of packets received from the user device and destined for the service provider network 107, from the local IP address of the user device to the network address (e.g., IP address) of the router/gateway 104. In the past, the source IP address of packets emanating from the router/gateway 104, which would comprise the known IP address of the router/gateway 104 on the service provider network 107, could be relied upon as a basis for determining that the user device that initiated the sending of the packet is located at the premises associated with the router/gateway (e.g., premises 101), for example, in order to enforce geographical restrictions placed on the delivery of a particular service or particular content. If the source IP address of a message (e.g., packet) received from a user device requesting access to a service or content did not match the known IP address of the router/gateway associated with that user device, entities associated with the service provider network, such as the authorization server 108, could assume that the user device was not located at the premises and could, for example, deny access to the requested service or content based on geographic restrictions. With the advent of new privacy products and services, however, the situation has become more complicated.

For example, existing privacy products may employ a virtual private network (VPN) device or a relay server, that may obfuscate the source IP address of packets emanating from a router/gateway on a service provider network. For example, in one scenario, a user of the user device 102 in FIG. 1 may wish to use the user device 102 to request access, via the service provider network 107, to content available on a content server of the service provider. To this end, a client application running on the user device 102 may send one or more messages, in the form of one or more packets, to the service provider via the router/gateway 104 and service provider network 107 requesting access to the content. These packets may ultimately be received by the authorization server 108. As the packets traverse the router/gateway 104, the router/gateway 104 may perform network address translation to change the source IP address of each packet from the local IP address of the user device 102 to the known IP address of the router/gateway 104 on the service provider network 107 (e.g., actual/known IP address 120 in FIG. 1). In the past, the authorization server 108 could match the source IP address in the transmitted packets with the known IP address of the user's router/gateway 104 to determine that the request for access to the content was being made from user device 102 at the premises 101.

However, with the advent of the aforementioned privacy services, a relay/VPN device or server 106 operated by such a privacy service may intercept the packets and obfuscate the source IP address of the router/gateway 104. For example, the relay device 106 may change the source IP address of the packets to an IP address associated with the relay device 106 (e.g., obfuscated network address 122 in FIG. 1). The goal of the privacy service is to make it difficult for recipients of the packets to know the true identity of the source of the packets. While this may facilitate added privacy, because the source IP address of the transmitted packets no longer matches the known IP address of the user's router/gateway 104, the authorization server 108 may mistakenly determine that the user device requesting access to the content is not located at the premises 101 and may, based on geographic restrictions, deny access to the requested content. Described herein are improved methods, systems, and apparatus for an authorization system to determine whether a user device is located at a premises, regardless of any obfuscation of IP addresses performed by a privacy service.

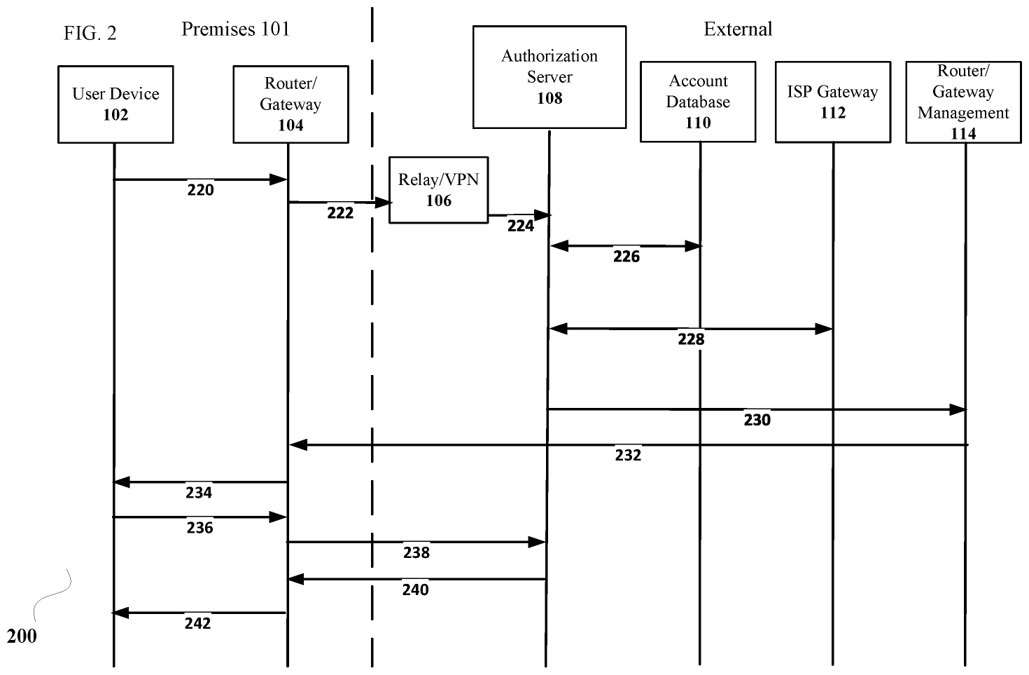

FIG. 2 shows an example method 200. The method may be employed in a system, such as the system of FIG. 1. The method may be used to determine whether a user device, such as the user device 102 of FIG. 1, is located, or present, at any geographical location or area such as a premises, such as the premises 101. The method 200 may be employed to determine whether the user device 102 is located at the premises 101 in order to enforce certain presence, location or geographic-based restrictions on access to content or services provided by a service provider.

At step 220, the user device 102 located at the premises 101, may send a message to the router/gateway 104 located at the premises 101. The message may comprise a request to access content or one or more services provided by a service provider. The message may be transmitted in the form of one or more packets, and each packet may comprise a source address of the user device 102 on a local network established by the router/gateway 104 at the premises 101. The source address of the user device 102 may comprise a local IP address, a device MAC address, or any other device identifier.

At step 222, the router/gateway 104 may be configured to send the packet(s) comprising the request message to an authorization server, such as the authorization server 108, of the service provider providing the requested content or service. The packet(s) comprising the request message may be sent via the service provider network 107. As mentioned above, the router/gateway 104 may be configured to perform network address translation (NAT) when sending the packet(s) comprising the request message from the user device 102 to the service provider network 107. Such network address translation may involve changing a source address in the header of the packet(s) received from the user device and destined for the service provider network 107, from the local IP address of the user device to the network address (e.g., IP address) of the router/gateway 104 on the service provider network 107. The packets may also maintain the address or identification of the user device in addition to or instead of the address of the router/gateway 104.

At step 224, a relay/VPN device or server 106, which may be operated by the service provider or by a third-party privacy service, may receive or intercept the packet(s) comprising the request message and may obfuscate the source IP address of the router/gateway 104 (or IP address of the user device) in the header of each packet. For example, the relay/VPM device 106 may change the source IP address of the packets to an IP address associated with the relay/VPN device 106. The relay/VPN device 106 may then forward the packet(s) with the obfuscated source IP address to the authorization server 108 of the service provider. The authorization server 108 may receive the packet(s) comprising the request message.

A goal of the relay/VPN device 106 may be to make it difficult for recipients of the packet(s) to know the true identity of the source of the packet(s). While this may facilitate added privacy, because the source IP address of the transmitted packets no longer matches the known IP address of the router/gateway 104 on the service provider network 107, the authorization server 108 may not be able to identify the user device, or may mistakenly determine that the user device requesting access to the content is not located at the premises 101. The authorization server 108 could, based on geographic or other restrictions, deny access to the requested content or service. However, described hereinafter is an improved method by which the authorization server 108 may determine whether the user device 102 is located at the premises 101, despite any obfuscation of IP addresses performed by the relay/VPN device 106.

The packet(s) comprising the request message that is received by the authorization server 108 may, in addition to the obfuscated source IP address, further comprise credentials associated with the user of the user device 102, such as, for example, a username and password associated with an account of the user. At step 226, the authorization server 108 may communicate with an account database, such as the account database 110. The account database 110 may store, for one or more users (e.g., customers of the service provider), information associated with an account the user has established with the service provider. The account information for each user may comprise, for example, the credentials associated with the user's account. The credentials may comprise, for example, an identifier associated with the user (e.g., a username, email address, or other identifier). The credentials may further comprises a password or other form of secure access token associated with the user identifier. The account database 110 may be a part of the authorization server 108 or may be a separate device/server in the service provider network 107.

In connection with receipt of the request message, the authorization server 108 may receive the user's credentials and access the account database 110 to validate the credentials and to confirm that the user has a valid account with the service provider, before providing access to services or content hosted by the service provider. The authorization server 108 may retrieve other information related to the user's account from the account database 110. Using the user's validated account information, at step 228, the authorization server 108 may communicate with the ISP gateway 112 to retrieve the known IP address allocated to the router/gateway 104 of the now validated user from which the request message was received. The ISP gateway 112 may store, for example in a database or other storage (not shown), the IP addresses allocated to the router/gateways of all users that have accounts with the service provider. The authorization server 108 may compare the known IP address of the user's router/gateway 104 with the source IP address retrieved from the header(s) of the packet(s) of the request message received from the user device 102 via the router/gateway 104 and service provider network 107.

The comparison may yield a match, (i.e. the known IP address of the user's router/gateway 104 matches the source IP address of the received packet(s) of the request message). If the comparison yields a match, then the authorization server 108 may make a determination that the user device 102 is at the premises, because the received packet(s) are confirmed to have been transmitted from the router/gateway 104 known to be located at the premises 101. Based on determining that the user device 102 is at the premises, the authorization server 108 may cause any requested content or service to be sent or made available to the user device 102 via the service provider network 107 and the router/gateway 104.

If the comparison does not yield a match (i.e., the known IP address of the user's router/gateway does not match the source IP address of the received packet(s) of the request message), the authorization server 108 may not send any requested content or provide access to any requested service. For example, the authorization server 108 may determine, based on the mismatch between the known IP address of the user's router/gateway 104 and the source IP address of the received packet(s) of the request message, that the user device 102 may not be located at the premises. Rather than deny access to the content or service altogether, however, the authorization server 108 may attempt to determine whether the user device is located at the premises, but the mismatch occurred as a result of network address obfuscation performed, for example, by a relay/VPN device, such as the relay/VPN device 106.

At step 230, the authorization server 108 may generate, create, or otherwise determine a code. The code may comprise a random secret code. The code may have any suitable length and/or complexity. For example, the code may comprise a numeric code comprising a number of digits. For example, the code may comprise a 6-digit numeric code. The code may comprise any other number of digits. The code may comprise an alpha-numeric code comprising a number of characters and digits. The code may comprise a token. For example, the code may comprise an OAuth2.0 token. The code may comprise a key. The code may comprise any other form of computer- or machine-recognizable data.

The authorization server 108 may send the code to the router management server 114. The authorization server 108 may send the code to the router/gateway management server 114 along with a message comprising a request for the router/gateway management server 114 to send the code to the user's router/gateway 104. The message sent by the authorization server 108 to the router/gateway management server 114 may include the known IP address of the user's router/gateway 104. Alternatively, or in addition, the message may include any other form of identification of the user's router/gateway 104.

At step 232, the router management server 114 may send a message to the user's router/gateway 104. The message may be sent via the service provider network 107. The message may be sent via a control plane of the service provider network 107. The message may be sent via a persisted control plane connection between the router management server 114 and the user's router/gateway 104 that is maintained between the router management server 114 and the user's router/gateway 104 for management of the router/gateway 104, including for router configuration updates, fault detection, accounting, performance, security management, and the like. The message may be sent using the known IP address of the user's router/gateway 104. The router/gateway management server 114 may have received the known IP address of the user's router/gateway 104 from the authorization server 108, as described above. Alternatively, the router/gateway management server 114 may receive the known IP address of the user's router/gateway 104 from the ISP gateway 112. The router/gateway management server 114 may obtain the known IP address of the user's router/gateway 104 by other means. For example, the router/gateway management server 114 may maintain its own database of IP addresses of users' routers/gateways on the service provider network 107.

The message sent to the user's router/gateway 104 in step 232 may comprise the code. The message may further comprise an instruction to the router/gateway 104 to transmit the code at the premises 101, such that it may be received by any user device, such as the user device 102, in the vicinity of the router/gateway 104 at the premises 101.

At step 234, based on receiving the message from the router/gateway management server 114, the router/gateway 104 may transmit the code at the premises. The router/gateway 104 may transmit the code at the premises by means of broadcast, multicast, or any other suitable means of transmitting the code at the premises 101 such that it may be received by user devices in the vicinity of the router/gateway 104 at the premises 101. For example, the router/gateway 104 may transmit the code via a user datagram protocol (UDP) broadcast on a local area network (LAN) established by the router/gateway 104 at the premises 101. The code may be broadcast on a specific port of the LAN. By broadcasting the code on the LAN network (which may be wireless or wired or both), only user devices that are located at the premises 101 and connected to the router/gateway 104 (e.g., wirelessly or via wire) may receive the code. The router/gateway 104 may transmit (e.g., broadcast, multicast, or otherwise transmit) the code for a pre-determined amount of time, such as a number of milliseconds, one second, three seconds, a minute, or any other shorter or longer predetermined amount of time.

At step 236, any user device located at the premises, such as, for example, the user device 102, may be listening for a code, such as the code sent by the router/gateway management server 114. For example, based on sending the request message in step 220, the user device 102, or an application hosted on the user device 102, may listen for a code. For example, the application hosted on the user device 102 may be listening for a UDP broadcast on the specific port mentioned above. If the user device 102 receives a code (i.e., the code transmitted by the router/gateway 104 at the premises), the user device 102 may be configured to send, via the user's router/gateway 104 and the service provider network 107, a second message to the authorization server 108. The second message may comprise the received code transmitted by the user's router/gateway 104. Alternatively, the received code may be used to create another code or token in accordance with an agreed protocol between the application hosted on the user device 102 and the authorization server 108, and the newly created code or token may be included in the second message.

At step 238, the router/gateway 104 may receive the second message comprising the code from the user device 102 and forward it to the authorization server 108 via the service provider network 107. At step 240, the authorization server 108 may receive the second message from the user device 102. The authorization server 108 may extract the code from the second message. The authorization server 108 may compare the code received in the second message with the code that the authorization server 108 instructed the router/gateway management server 114 to send to the user's router/gateway 104. If the received code matches the code instructed to be sent, the authorization server 108 may determine that the user device 102 is located at the premises 101. Based on determining that the user device 102 is located at the premises 101, the authorization server 108 may cause the content and/or service requested in the request message sent in step 220 to be delivered and/or made available to the user device 102, via the user's router/gateway 104, as shown at steps 240 and 242.

After instructing the router/gateway management server 114 to send the code to the user's router gateway 104 in steps 230 and 232, the authorization server 108 may wait a predetermined amount of time for receipt, from the user device, of a second message comprising the code. If the authorization server 108 does not receive a second message comprising the code within the predetermined amount of time, or if any code received in a second message from the user device 102 within the predetermined amount of time does not match the code requested by the authorization server 108 to be transmitted at the user's premises 101, then the authorization server 108 may determine that the user device 102 is not located at the premises 101. Based on determining that the user device 102 is not located at the premises 101, the authorization server 108 may cause access to the requested content and/or service to be denied, for example, based on geographic restrictions associated with the content or service.

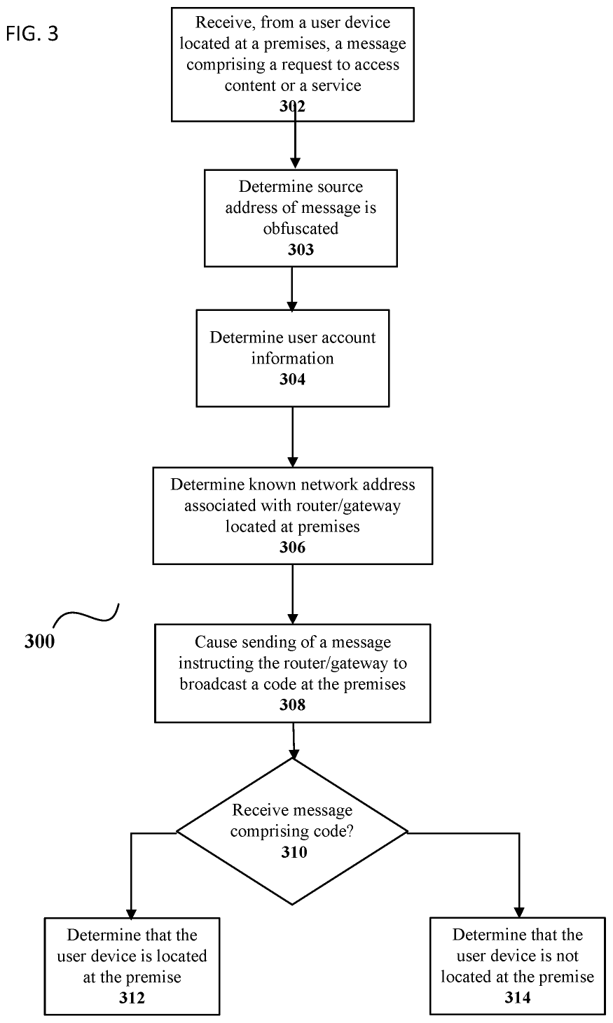

FIG. 3 shows an example method 300. The method 300 may be employed to determine if a user device is located at a premises. The method 300 may be employed in the system illustrated in FIG. 1. The method 300 may be implemented as part of, or in combination with, the method illustrated in FIG. 2. The method of FIG. 3 may be performed by a computing device, such as any computing device illustrated in FIG. 1. For example, the method 300 may be performed by the authorization server 108, the ISP gateway 112, and/or the router/gateway management server 114 of FIG. 1, or any combination thereof.

In step 302, a message may be received from a user device, such as the user device 102 of FIG. 1. The message may be received via a router or gateway located at a premises associated with a user of the user device, such as the user's home, business, or other geographic location. The message may comprise a request, by the user device, for access to content or a service. The message may be received, for example, by an authorization system, such as the authorization server 108 of FIG. 1. The message may comprise a user identifier associated with the user of the user device. The message may comprise a source address. The source address may comprise a network address associated with the router/gateway located at the user's premises. The network address may comprise an IP address.

In step 303, the source address of the message received in step 302 may be determined to be obfuscated. The source address of the message may be determined to be obfuscated by determining that the source address is not associated with any user account. The source address of the message may be determined to be obfuscated by comparing the source address to a known network address associated with an account of the user identified by the user identifier in the received message. The known source address associated with the user may comprise a network address associated with the router/gateway known to be located at the premises associated with the user. Alternatively, or in addition, the source address of the message may be determined to be obfuscated by comparing the received source address to all known network addresses associated with users having valid accounts within a system, such as the system illustrated in FIG. 1, and determining that the received source address does not match any known network address. The source address may have been obfuscated by a relay server, VPN device, or other device or function configured to obfuscate source addresses in packets sent over a network.

Based on determining that the source address (e.g., network address) in the received message is obfuscated (e.g., the source address is not associated with any user account of the system, including the user account associated with the user identified by the user identifier in the received message), at step 304, user account information associated with the user identified by the user identifier in the received message may be determined. The user account information may be determined, for example, by sending the user identifier to an account database (e.g., account database 110) and receiving, from the account database, the user account information.

At step 306, based on the user account information associated with the user identified by the user identifier in the received message, a known network address associated with a router/gateway located at a premises of the user may be determined. For example, the known network address may be determined by sending all or some of the user account information to a gateway of a service provider (e.g., ISP gateway 112) and receiving from the gateway, the known network address of the router/gateway associated with the user account information.

In step 308, based on the known network address of the router/gateway at the user's premises, a message may be caused to be sent to the user's router/gateway instructing the router/gateway to transmit (e.g., broadcast, multicast, or otherwise transmit) a code at the premises. As discussed above in connection with FIG. 2, for example, an authorization system, such as the authorization server 108, may communicate with a router/gateway management server, such as the router/gateway management server 114, to cause the message to be sent to the user's router/gateway located at the premises. The message may be sent to the user's router/gateway via a control plane of a service provider network. The code may comprise a random secret code. The code may comprise any other form of computer- or machine-recognizable data.

At step 310, it may be determined whether a second message is received, from the user device 102, comprising the code. The second message may be received, for example, by the authorization server 108, via the service provider network 107.

If at step 310, it is determined that a second message was received comprising the code instructed to be transmitted (e.g., broadcast, multicast, or otherwise transmitted) by the router/gateway at the user's premises, then at step 312, it may be determined that the user device requesting access to content or a service is located at the premises. Based on determining that the user device is located at the premises, the requested content or service may be sent or made accessible to the user device. In the case of content, the content may be sent to the user device using the obfuscated source address in the request message.

If at step 310, it is determined that a second message comprising the code was not received, or a second message comprising a different code was received, it may be determined in step 314 that the user device is not located at the premises. Based on determining that the user device is not located at the premises, access to the content or service requested by the user device may be denied.

After causing, in step 308, the code to be sent to the user's router/gateway with an instruction for the router/gateway to transmit (e.g., broadcast, multicast, or otherwise transmit) the code at the premises, the sender of the message may wait a predetermined amount of time for receipt from the user device of a second message comprising the code. If a second message comprising the code is not received within the predetermined amount of time, or if any code received in a second message from the user device 102 within the predetermined amount of time does not match the code instructed to be transmitted by the router/gateway at the user's premises, then it may be determined that the user device is not located at the premises.

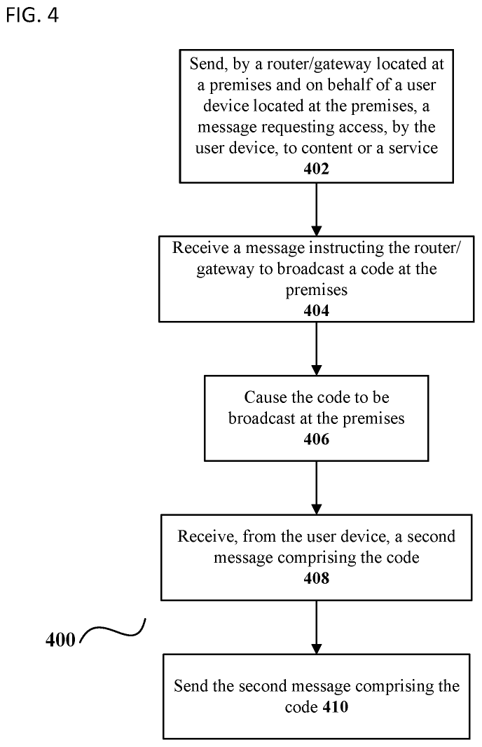

FIG. 4 shows an example method 400. The method 400 may be employed to determine if a user device is located at a premises. The method 400 may be employed in the system illustrated in FIG. 1. The method 400 may be implemented as part of, or in combination with, the method illustrated in FIG. 2. The method of FIG. 4 may be performed by a router or gateway located at a premises, such as the router/gateway 104 illustrated in FIG. 1.

At step 402, a router/gateway located at premises may send, to a computing device on a network, such as the authorization server 108 on the service provider network 107 of FIG. 1, a message requesting access to content or a service. The message may have initiated from a user device configured to communicate with the router/gateway at the premises. The message may comprise a user identifier associated with a user of the user device. The message may comprise a source address, such as a network address (e.g., IP address) associated with the router/gateway. The source address of the router/gateway may subsequently become obfuscated. For example, a relay server or VPN device may obfuscate the source address after the message is transmitted by the router/gateway.

At step 404, the router/gateway may receive, from the network, a message to transmit a code at the premises. The message may comprise the code. The code may comprise a random secret code. The code may comprise any other form of computer or machine recognizable data.

At step 406, the router/gateway may cause, based on receiving the message, the code to be transmitted. The code may be transmitted via broadcast, multicast, or any other means of transmitting the code at the premises such that devices located at the premises may receive the code. The code may be transmitted wirelessly, such that devices in the vicinity of the router/gateway at the premises may be able to receive the code. The code may be transmitted via a wireless network established by the router/gateway at the premises. For example, the code may be transmitted via a wireless network operating in accordance with the IEEE 802.11 (“Wi-Fi”) standard. In other implementations, other radio technologies may be employed, such as IEEE 802.16 or 802.20 (“WiMAX”), IEEE 802.15.4a (“Zigbee”), or 802.15.3c (“UWB”). The code may also be transmitted to devices that may be connected to the router/gateway at the premises by a wired connection, such as, for example, via an IEEE 802.3 (“Ethernet”) connection or the like. The router/gateway may transmit (e.g., broadcast, multicast, or otherwise transmit) the code for a pre-determined amount of time, such as a number of milliseconds, one second, three seconds, a minute, or any other shorter or longer predetermined amount of time.

At step 408, the router/gateway may receive, from one or more devices located at the premises, such as the user device that requested access to the content or service, a second message comprising the code. That is, because the user device is located at the premises, it may have received the code transmitted (e.g., broadcast, multicast, etc.) by the router/gateway at the premises. Upon receiving the code, the user device, or an application hosted on the user device, may be configured to send a message to the network, via the router/gateway, comprising the code. The router/gateway may receive the message from the user device and, at step 410, send (e.g., forward) the message to the authorization system from which the user device has requested access to the content or service, such as, for example, the authorization server 108 of FIG. 1. As discussed above, the receipt by the authorization system, from the user device, of the second message comprising the code enables the authorization system to determine that the user device is located at the premises, in order to enforce certain geographic restrictions that may be placed on delivery of the requested content or access to the requested service.

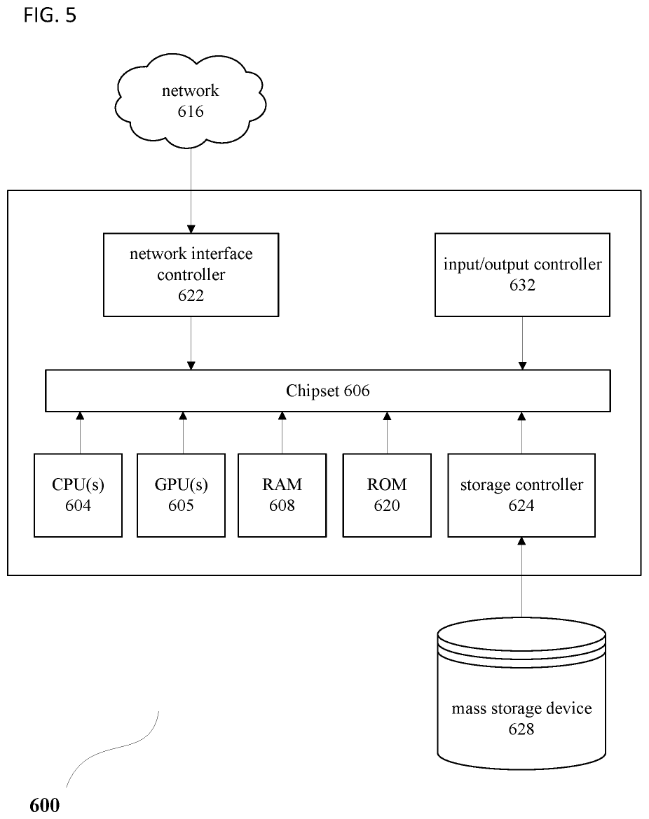

FIG. 5 shows an example computing device 600 that may represent any of the various devices or entities shown in FIG. 1, including, for example, the user device 102, the router/gateway 104, the relay/VPN device 106, the authorization server 108, the account database 110, the ISP gateway 112, and the router/gateway management server 114. The computing device 600 shown in FIG. 6 may comprise any smartphone, server computer, workstation, access point, router, gateway, tablet computer, laptop computer, notebook computer, desktop computer, personal computer, network appliance, PDA, e-reader, user equipment (UE), mobile station, fixed or mobile subscriber unit, pager, wireless sensor, consumer electronics, or other computing device, and may be utilized to execute any aspects of the methods and apparatus described herein, such as to implement any of the apparatus of FIGS. 1 and 2 or any of the methods described in relation to FIGS. 2-4.

The computing device 600 may comprise a baseboard, or “motherboard,” which is a printed circuit board to which a multitude of components or devices may be connected by way of a system bus or other electrical communication paths. One or more central processing units (CPUs or “processors”) 604 may operate in conjunction with a chipset 606. The CPU(s) 604 may be standard programmable processors that perform arithmetic and logical operations necessary for the operation of the computing device 600.

The CPU(s) 604 may perform the necessary operations by transitioning from one discrete physical state to the next through the manipulation of switching elements that differentiate between and change these states. Switching elements may generally comprise electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, or the like.

The CPU(s) 604 may be augmented with or replaced by other processing units, such as GPU(s) 605. The GPU(s) 605 may comprise processing units specialized for but not necessarily limited to highly parallel computations, such as graphics and other visualization-related processing.

A chipset 606 may provide an interface between the CPU(s) 604 and the remainder of the components and devices on the baseboard. The chipset 606 may provide an interface to a random-access memory (RAM) 608 used as the main memory in the computing device 600. The chipset 606 may provide an interface to a computer-readable storage medium, such as a read-only memory (ROM) 620 or non-volatile RAM (NVRAM) (not shown), for storing basic routines that may help to start up the computing device 600 and to transfer information between the various components and devices. ROM 620 or NVRAM may also store other software components necessary for the operation of the computing device 600 in accordance with the aspects described herein.

The computing device 600 may operate in a networked environment using logical connections to remote computing nodes and computer systems of the system 100. The chipset 606 may comprise functionality for providing network connectivity through a network interface controller (NIC) 622. A NIC 622 may be capable of connecting the computing device 600 to other computing nodes over the system 100. It should be appreciated that multiple NICs 622 may be present in the computing device 600, connecting the computing device to other types of networks and remote computer systems. The NIC 622 may be configured to implement a wired local area network technology, such as IEEE 802.3 (“Ethernet”) or the like. The NIC 622 may also comprise any suitable wireless network interface controller capable of wirelessly connecting and communicating with other devices or computing nodes on the system 100. For example, the NIC 622 may operate in accordance with any of a variety of wireless communication protocols, including for example, the IEEE 802.11 (“Wi-Fi”) protocol, the IEEE 802.16 or 802.20 (“WiMAX”) protocols, the IEEE 802.15.4a (“Zigbee”) protocol, the 802.15.3c (“UWB”) protocol, or the like.

The computing device 600 may be connected to a mass storage device 628 that provides non-volatile storage (i.e., memory) for the computer. The mass storage device 628 may store system programs, application programs, other program modules, and data, which have been described in greater detail herein. The mass storage device 628 may be connected to the computing device 600 through a storage controller 624 connected to the chipset 606. The mass storage device 628 may consist of one or more physical storage units. A storage controller 624 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 600 may store data on a mass storage device 628 by transforming the physical state of the physical storage units to reflect the information being stored. The specific transformation of a physical state may depend on various factors and on different implementations of this description. Examples of such factors may comprise, but are not limited to, the technology used to implement the physical storage units and whether the mass storage device 628 is characterized as primary or secondary storage or the like.

For example, the computing device 600 may store information to the mass storage device 628 by issuing instructions through a storage controller 624 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 600 may read information from the mass storage device 628 by detecting the physical states or characteristics of one or more particular locations within the physical storage units.

In addition to the mass storage device 628 described herein, the computing device 600 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 600.

By way of example and not limitation, computer-readable storage media may comprise volatile and non-volatile, non-transitory computer-readable storage media, and removable and non-removable media implemented in any method or technology. However, as used herein, the term computer-readable storage media does not encompass transitory computer-readable storage media, such as signals. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other non-transitory medium that may be used to store the desired information in a non-transitory fashion.

A mass storage device, such as the mass storage device 628 depicted in FIG. 5, may store an operating system utilized to control the operation of the computing device 600. The operating system may comprise a version of the LINUX operating system. The operating system may comprise a version of the WINDOWS SERVER operating system from the MICROSOFT Corporation. According to additional aspects, the operating system may comprise a version of the UNIX operating system. Various mobile phone operating systems, such as IOS and ANDROID, may also be utilized. It should be appreciated that other operating systems may also be utilized. The mass storage device 628 may store other system or application programs and data utilized by the computing device 600.

The mass storage device 628 or other computer-readable storage media may also be encoded with computer-executable instructions, which, when loaded into the computing device 600, transforms the computing device from a general-purpose computing system into a special-purpose computer capable of implementing the aspects described herein. These computer-executable instructions transform the computing device 600 by specifying how the CPU(s) 604 transition between states, as described herein. The computing device 600 may have access to computer-readable storage media storing computer-executable instructions, which, when executed by the computing device 600, may perform the methods described in relation to FIGS. 2-4.

A computing device, such as the computing device 600 depicted in FIG. 5, may also comprise an input/output controller 632 for receiving and processing input from a number of input devices, such as a keyboard, a mouse, a touchpad, a touch screen, an electronic stylus, or other type of input device. Similarly, an input/output controller 632 may provide output to a display, such as a computer monitor, a flat-panel display, a digital projector, a printer, a plotter, or other type of output device. It will be appreciated that the computing device 600 may not comprise all of the components shown in FIG. 5, may comprise other components that are not explicitly shown in FIG. 5, or may utilize an architecture completely different than that shown in FIG. 5.

As described herein, a computing device may be a physical computing device, such as the computing device 600 of FIG. 5. A computing device may also comprise a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems described herein are not limited to specific methods, specific components, or to particular implementations. It is also to be understood that the terminology used herein is not intended to be limiting.

As used in the specification and the appended claims, the singular forms “a,” “an,” and “the” comprise plural referents unless the context clearly dictates otherwise. Ranges may be expressed herein as from “about” one particular value, and/or to “about” another particular value. When such a range is expressed, another example may comprise from the one particular value and/or to the other particular value. It will be further understood that the endpoints of each of the ranges are significant both in relation to the other endpoint, and independently of the other endpoint.

“Optional” or “optionally” means that the subsequently described event or circumstance may or may not occur, and that the description comprises instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers, or steps. “Exemplary” means “an example of.”. “Such as” is not used in a restrictive sense, but for explanatory purposes.

Components and devices are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any combination of the described methods.

As will be appreciated by one skilled in the art, the methods and systems may take the form of entirely hardware, entirely software, or a combination of software and hardware aspects. Furthermore, the methods and systems may take the form of a computer program product on a computer-readable storage medium having computer-readable instructions (e.g., computer software or program code) embodied in the storage medium. More particularly, the present methods and systems may take the form of web-implemented computer software. Any suitable computer-readable storage medium may be utilized including hard disks, CD-ROMs, optical storage devices, or magnetic storage devices.

The methods and systems are described above with reference to block diagrams and flowcharts of methods, systems, apparatuses, and computer program products. It will be understood that each block of the block diagrams and flowcharts, and combinations of blocks in the block diagrams and flowcharts, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described herein may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added or removed. The example systems and components described herein may be configured differently than described. For example, elements may be added to, removed from, or rearranged.

It will also be appreciated that various items are shown as being stored in memory or on storage while being used, and that these items or portions thereof may be transferred between memory and other storage devices for purposes of memory management and data integrity. Alternatively, some or all of the software modules and/or systems may execute in memory on another device and communicate with the shown computing systems via inter-computer communication. Furthermore, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms. Accordingly, the present invention may be practiced with other computer system configurations.

While the methods and systems have been described in connection with specific examples, it is not intended that the scope be limited to the specific examples set forth.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including matters of logic with respect to arrangement of steps or operational flow and the plain meaning derived from grammatical organization or punctuation.

It will be apparent to those skilled in the art that various modifications and variations may be made without departing from the scope or spirit of the present disclosure. Alternatives will be apparent to those skilled in the art from consideration of the specification and practices described herein. It is intended that the specification and example figures be considered as exemplary only, with a true scope and spirit being indicated by the following claims.

What is claimed is:

1. A method comprising:
receiving, by a computing device, from a user device located at a premises and via a router located at the premises, a first message requesting access to a service, wherein the first message comprises an identifier associated with the user device;
sending, to the router, a second message comprising a code and an instruction to transmit the code at the premises;
receiving, by the computing device, from the user device and via the router, a third message comprising the code; and
determining, based on receiving the third message comprising the code, that the user device is located at the premises.

2. The method of claim 1, wherein the first message further comprises an obfuscated network address associated with the router, and wherein the method further comprises:
based on determining that the obfuscated network address is not associated with a user account, determining user account information associated with the identifier associated with the user device;
determining, based on the user account information associated with the identifier, a known network address associated with the router; and
sending the second message to the router based on the known network address of the router.

3. The method of claim 2, wherein the obfuscated network address is obfuscated by a relay server or a VPN device.

4. The method of claim 1, wherein the code comprises at least one of: a random secret code, a token, a numeric code, an alpha-numeric code, or a key.

5. The method of claim 2, wherein the determining the user account information associated with the identifier comprises:
sending, by the computing device and to an account database, the identifier; and
receiving, by the computing device and from the account database, the user account information.

6. The method of claim 2, wherein the determining the known network address associated with the router comprises:
sending, by the computing device, to a service provider gateway, the user account information;
receiving, by the computing device, from the service provider gateway, the known network address of the router associated with the user account information.

7. The method of claim 1, wherein the determining that the user device is located at the premises comprises determining that the code in the third message matches the code in the second message.

8. The method of claim 2, wherein the known network address of the router comprises an internet protocol (IP) address.

9. The method of claim 1, further comprising causing, by the computing device and based on determining that the user device is located at the premises, sending of requested content to the user device.

10. A method comprising:
sending, by a router located at a premises and to a computing device, a first message from a user device located at the premises requesting access to a service, wherein the first message comprises an identifier associated with the user device;
receiving, by the router, from the computing device, a second message comprising a code and an instruction to transmit the code to at least the user device;
causing, based on the second message, the code to be transmitted;
receiving, by the router, from the user device, a third message comprising the code; and
sending, by the router and to the computing device, the third message comprising the code.

11. The method of claim 10, wherein the code is transmitted by one of:
a broadcast transmission; or
a multicast transmission.

12. The method of claim 10, wherein the code comprises a random secret code.

13. The method of claim 10, further comprising:
based on sending the third message comprising the code, receiving requested content from the computing device; and
sending the requested content to the user device.

14. The method of claim 10, wherein the known network address of the router comprises an internet protocol (IP) address.

15. The method of claim 10, further comprising causing, based on sending the first message, the router to listen for the second message.

16. A method comprising:
receiving, by a computing device, from a user device located at a premises and via a router located at the premises, a first message requesting access to a service, wherein the first message comprises an identifier associated with the user device;
sending, to the router, a second message comprising a code and an instruction to transmit the code at the premises;
determining, based on a failure to receive, from the user device and via the router, a third message comprising the code, that the user device is not located at the premises.

17. The method of claim 16, wherein the code comprises a random secret code.

18. The method of claim 16, further comprising:
sending, by the computing device and to an account database, the identifier associated with the user device; and
receiving, by the computing device and from the account database, user account information.

19. The method of claim 18, further comprising:
sending, by the computing device, to a service provider gateway, the user account information;
receiving, by the computing device, from the service provider gateway, a known network address of the router associated with the user account information; and
sending the second message to the router using the known network address of the router.

20. The method of claim 15, wherein determining that the user device is not located at the premises comprises determining that a third message comprising the code was not received within a predetermined amount of time.
